(19) United States
(12) Patent Application Publication
(10) Pub. No.: US 2025/0217944 A1
(43) Pub. Date: Jul. 3, 2025

(54) Quad-Photodiode (QPD) Image Deblurring Using Convolutional Neural Network

(71) Applicant: OmniVision Technologies, Inc., Santa Clara, CA (US)

(72) Inventors: Xiaodong Yang, San Jose, CA (US); Hang Chen, Wuhan City (CN); Wenkai Su, Wuhan (CN); Hongtao Yu, Wuhan City (CN); Yin Xie, Wuhan City (CN); Shaohui Song, Wuhan City (CN); Lihu Sun, Wuhan City (CN); Chengming Liu, Fremont, CA (US)

(73) Assignee: OmniVision Technologies, Inc., Santa Clara, CA (US)

(21) Appl. No.: 18/965,318

(22) Filed: Dec. 2, 2024

Related U.S. Application Data
(60) Provisional application No. 63/616,874, filed on Jan. 2, 2024.

(51) Int. Cl. G06T 5/73; G06T 5/60

(52) U.S. Cl. CPC G06T 5/73; G06T 5/60; G06T 2207/20084

(57) ABSTRACT

A blurred QPD image is divided into an Up-left (Ul) view, an Up-right (Ur) view, a Down-left (Dl) view, and a Down-right (Dr) view. A U view is the mean of the Ul view and the Ur view, a D view is the mean of the Dl view and the Dr view, a L view is the mean of the Ul view and the Dl view; and a R view is the mean of the Ur view and the Dr view. The U view, the D view, the L view, and the R view are input into a convolutional neural network (CNN). The CNN outputs an output Bayer image, which is a deblurred image of the blurred QPD image.

### CROSS-REFERENCE TO RELATED APPLICATION

This application claims the benefits of the U.S. Provisional Application No. 63/616,874, filed Jan. 2, 2024, which is hereby incorporated by reference.

### FIELD OF THE INVENTION

This invention relates to quad-photodiode (QPD) image deblurring, and particularly QPD image deblurring using convolutional neural network (CNN).

### BACKGROUND OF THE INVENTION

A digital camera can perform autofocus using dual-photodiode (DPD) or quad-photodiode (QPD) complementary-metal-oxide-semiconductor (CMOS) image sensor. A pixel unit of DPD image sensor comprises two photodiodes or two pixels under a microlens. A pixel unit of QPD image sensor comprises four photodiodes or four pixels under a microlens. Autofocus using DPD image sensor is based on disparity along the direction of its pixels of a pixel unit. Only one direction of disparity is available. If a part of an image has 1D pattern only, there is possibility that the part of the image shows no disparity, even the image is not focused, depending on the direction of the DPD. In contrast, autofocus using QPD image sensor is based on disparity along two orthogonal directions of its four pixels of a pixel unit. Two orthogonal directions of disparity are available so that the QPD image sensor will not miss any defocused image.

Generally, an image comprises various parts having different distances from the camera, thus, even if a part is well focused, for example, using autofocus QPD, other parts may not be in focus or out-of-focus. The out-of-focus part may result in blurred image. In some applications, all well focused parts may be needed in an image. Autofocus applications of QPD are ubiquitous, but methods and systems that can produce deblurred images are still needed. Algorithms for QPD image deblurring may be available, but methods and systems for QPD image deblurring based on deep learning, non-algorithm type (not rule based), are still not available or not widely available, which are thus demanded.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 illustrates a deblurring CNN.

FIG. 2A schematically shows camera lens at out-of-focus position.

FIG. 2B schematically shows camera lens at in-focus position.

FIG. 2C schematically shows camera lens at out-of-focus position.

FIG. 3A illustrates a DPD pixel unit of a CMOS image sensor.

FIG. 3B illustrates a DPD pixel unit as seen from the top of pixel unit.

FIG. 4A illustrates a DPD pixel unit array comprising a plurality of DPD pixel units.

FIG. 4B shows left view and right view of a DPD image.

FIG. 5 illustrates a DPD deblurring CNN.

FIG. 6 illustrates a QPD pixel unit array of a CMOS image sensor.

FIG. 7A illustrates a QPD pixel unit array similar to FIG. 6, except microlenses are removed from the figure, according to an embodiment of the invention.

FIG. 7B shows Ul view, Ur view, Dl view, and Dr view of a QPD image, according to an embodiment of the invention.

FIG. 8A shows a U view, according to an embodiment of the invention.

FIG. 8B shows a D view, according to an embodiment of the invention.

FIG. 8C shows an L view, according to an embodiment of the invention.

FIG. 8D shows an R view, according to an embodiment of the invention.

FIG. 9A illustrates a part of a QPD deblurring CNN, according to an embodiment of the invention.

FIG. 9B illustrates another part of the QPD deblurring CNN, according to an embodiment of the invention.

FIG. 10 shows a flowchart of a QPD deblurring CNN, according to an embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention.

### DETAILED DESCRIPTION

In the following description, numerous specific details are set forth in order to provide a thorough understanding of the present invention. It will be apparent, however, to one having ordinary skill in the art that the specific detail need not be employed to practice the present invention. In other instances, well-known materials or methods have not been described in detail in order to avoid obscuring the present invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment. Furthermore, the particular features, structures or characteristics may be combined in any suitable combinations and/or sub-combinations in one or more embodiments.

A convolutional neural network (CNN) is a type of deep learning neural network that is well-suited for image and video analysis. CNNs use a series of convolution and pooling layers to extract features from images, and then use these features to classify or detect objects or scenes, or other processing. The basic principle of a CNN is to automatically learn and extract features from input data, typically images, through the use of convolution layers.

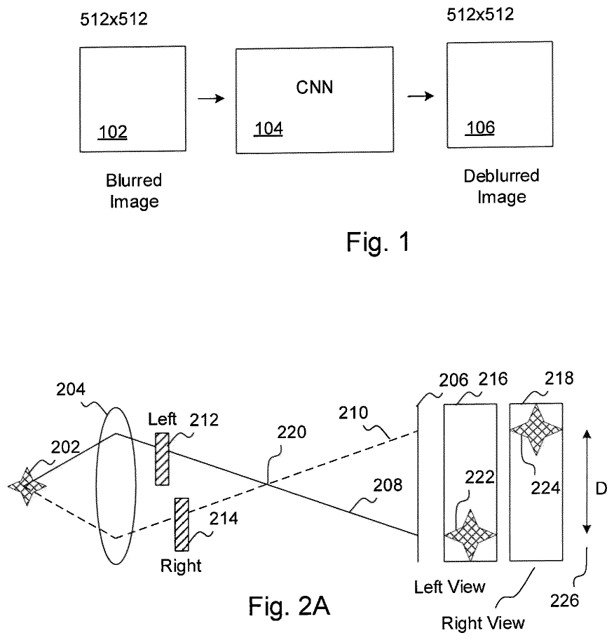

FIG. 1 illustrates a deblurring CNN 104. An input 102, which is a blurred image, is input to CNN 104. CNN 104 then outputs an output 106, which is a deblurred image. For example, input 102 is a 512×512 blurred image, and output 106 is a 512×512 deblurred image of input 102. The whole input may be larger than 512×512. The 512×512 is the window size of the processed input at a time.

CNN 104 is trained to get features of input blurred image in the deep learning process. Different blurred images may have common blurred features indicating that the image is blurred. CNN 104 is then trained to deblur the input image based on blurred features in deep learning process. The trained CNN 104 outputs the deblurred image as output 106.

Inputs from various images are used in the learning process to recognize their common features. After CNN 104 is trained, an image, not necessarily those have been used in the learning process, can be processed in the trained CNN 104 to output its deblurred image. For example, features of a blurred image may include lacking sharp edges or having blurred groups of pixels, among others.

A digital camera may include a camera lens and an image sensor. The lens formed the image of an object on the image sensor. The digital camera may be a camera installed in a smart phone, or may be a digital single lens reflex (SLR) camera. A phase detection autofocus (PDAF) image sensor may be used in a camera. Together with a lens driven by an actuator, the PDAF image sensor may perform autofocus.

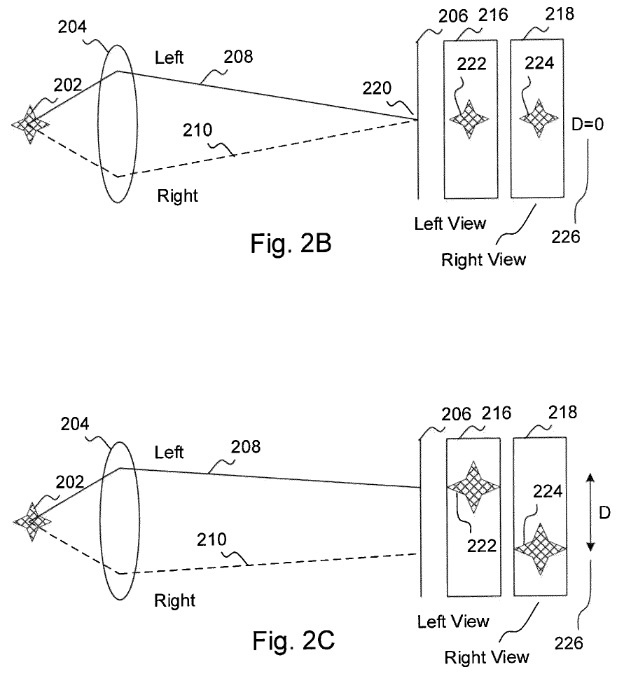

FIGS. 2A-2C illustrate the principle of PDAF. Notice that all drawings are not to scale. A lens 204, which is a camera lens, images an object 202 on a plane 206. Light 208 passes a half of lens 204. For example, light 208 passes the left half of lens 204. Light 210 passes the right half of lens 204. FIG. 2A shows that if a left mask 212 is placed to block light 208, only light 210 will form a right image 224 on plane 206. A right view 218 including right image 224 will be formed on plane 206. If a right mask 214 is placed to block light 210, only light 208 will form a left image 222 on plane 206. A left view 216 including left image 222 will be formed on plane 206.

FIG. 2A schematically shows lens 204 at an out-of-focus position. Focus 220 is at the front of plane 206. On plane 206, left image 222 in left view 216 formed by left light 208 is shifted in horizontal direction (left right direction) from right image 224 in right view 218 formed by right light 210. In this situation, left image 222 and right image 224 are blurred images of object 202. The distance between left image 222 and right image 224 is disparity (D) 226. The blurs of left image 222 and right image 224, and disparity 226 depend on the out-of-focus position of lens 204. The blurs and the disparity are correlated.

FIG. 2B schematically shows lens 204 at an in-focus position. Focus 220 is at plane 206. On plane 206, left image 222 in left view 216 formed by left light 208 overlaps with right image 224 in right view 218 formed by right light 210. In this situation, left image 222 and right image 224 are sharp or deblurred images of object 202. The distance between left image 222 and right image 224 or disparity (D) 226 is zero. In other words, deblurring is same as finding the in-focus image, where disparity is zero.

FIG. 2C schematically shows lens 204 at an out-of-focus position. Focus 220 is at the back of plane 206 (not shown). On plane 206, left image 222 in left view 216 formed by left light 208 is shifted in horizontal direction (left right direction) in reversed direction of FIG. 2A from right image 224 in right view 218 formed by right light 210. In this situation, left image 222 and right image 224 are blurred images of object 202. The distance between left image 222 and right image 224 is disparity (D) 226. The blurs of left image 222 and right image 224, and disparity 226 depend on the out-of-focus position of lens 204. The blurs and the disparity are correlated.

In an embodiment, a PDAF CMOS image sensor comprises a plurality of PDAF pixel units. A PDAF pixel unit may comprise two separate photodiodes under a microlens, which is known as DPD (dual-photodiode). In an embodiment, a photodiode may be considered a pixel, because they form a smallest element of image. For the ease of explanation, the word photodiode is used interchangeably with the word pixel in this disclosure. Thus, one may describe two pixels under a microlens forming a DPD pixel unit.

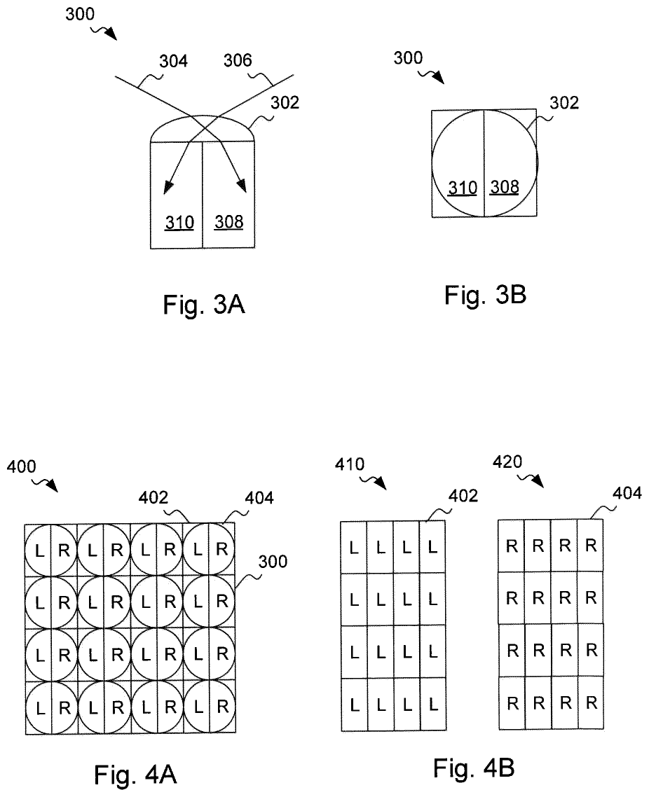

FIG. 3A illustrates a DPD pixel unit 300 of a CMOS image sensor. Pixel unit 300 has two pixels 308 and 310, which are two isolated photodiodes, under a shared microlens 302. The incident light comprises right light 304 and left light 306. Microlens 302 focuses incident right light 304 to right pixel 308 of pixel unit 300. Right light 304 is right light 210 of FIGS. 2A-2C. A collection of right pixels 308 will form a right view such as right view 218 of FIGS. 2A-2C. The same microlens 302 focuses incident left light 306 to left pixel 310 of pixel unit 300. Left light 306 is left light 208 of FIGS. 2A-2C. A collection of left pixels 310 will form a left view such as left view 216 of FIGS. 2A-2C.

FIG. 3B illustrates DPD pixel unit 300 as seen from the top of pixel unit. Notice that FIG. 3A illustrates DPD pixel unit 300 as seen from the side of pixel unit. Note that the naming of left and right is arbitrary, thus one may refer to the corresponding figure.

FIG. 4A illustrates a DPD pixel unit array 400 comprising a plurality of DPD pixel units 300. It is understood that the number of pixels is much larger than what is shown in the figure. A DPD pixel unit 300 comprises a left (L) pixel or photodiode 402 and a right (R) pixel or photodiode 404. Left pixel 402 may be left pixel 310 of FIGS. 3A-3B. Right pixel 404 may be right pixel 308 of FIGS. 3A-3B.

FIG. 4B shows a collection of L pixels 402 forming a left view 410 such as left view 216 of FIGS. 2A-2C. FIG. 4B also shows a collection of R pixels 404 forming a right view 420 such as right view 218 of FIGS. 2A-2C.

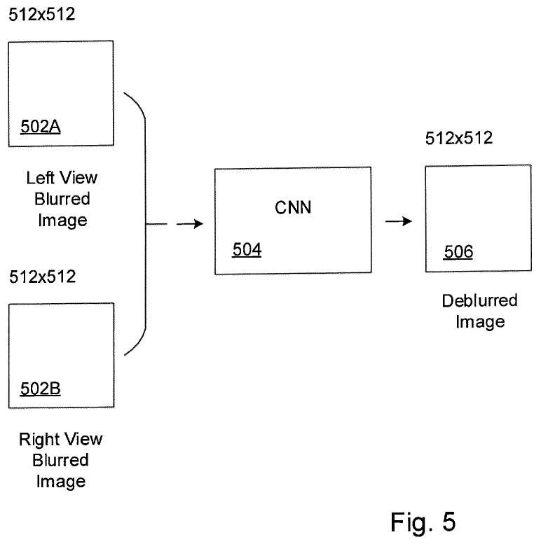

FIG. 5 illustrates a DPD deblurring CNN 504. An input 502A, which is a left view of a blurred image, and an input 502B, which is a right view of the blurred image, are input to CNN 504. CNN 504 then outputs an output 506, which is a deblurred image. Input 502A may be left view 410 of FIG. 4B or left view 216 of FIGS. 2A-2C. Input 502B may be right view 420 of FIG. 4B or right view 218 of FIGS. 2A-2C. The blurred image may be a blurred image of object 202 of FIGS. 2A-2C. For example, input 502A is a 512×512 left view, input 502B is a 512×512 right view, and output 506 is a 512×512 deblurred image. Note that 512×512 is the number of pixels.

Comparing to FIG. 1, in which CNN 104 produces deblurred image based on a single input image 102 that comprises blur information only, CNN 504 in FIG. 5 produces deblurred image based on blur information and disparity given in left view and right view of a blurred image, thus CNN 504 in FIG. 5 based on DPD image produces better deblurred image.

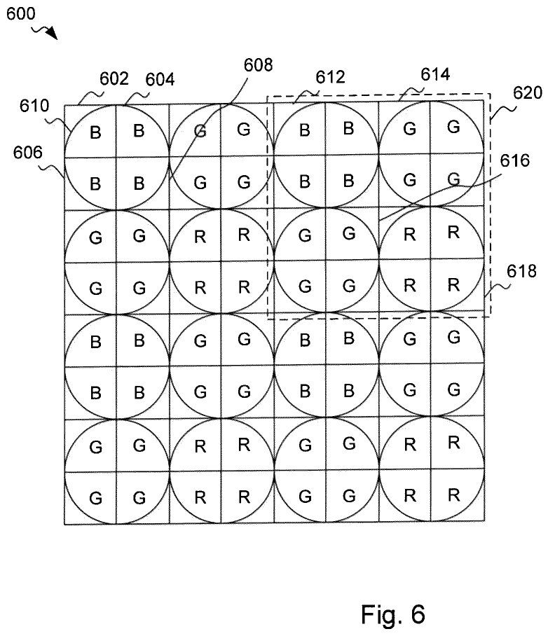

FIG. 6 illustrates a QPD (quad-photodiode) pixel unit array 600 of a CMOS image sensor. Each pixel unit comprising four photodiodes or four pixels 602, 604, 606, 608 of the same color, is covered by a microlens 610. Pixel units of blue 612, green 614, green 616, and red 618 form a Bayer pattern 620. It is understood that the number of pixels is much larger than what is shown in the figure.

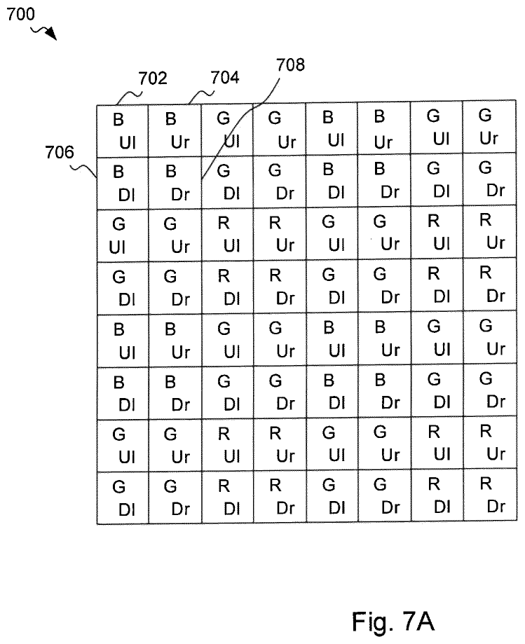

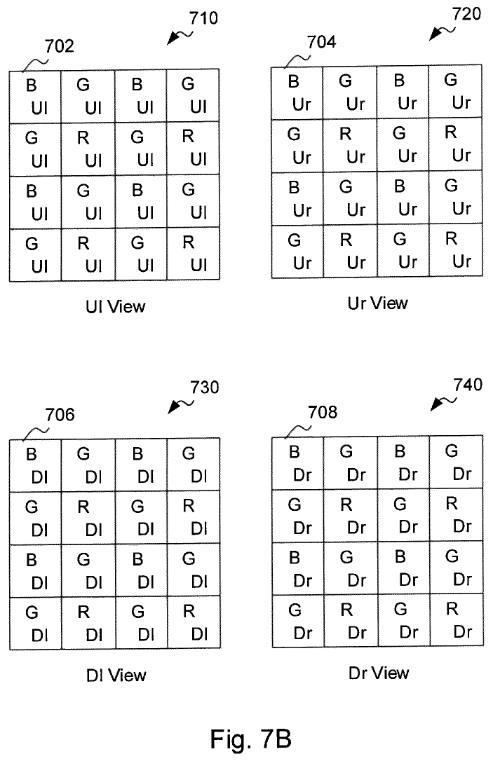

FIG. 7A illustrates a QPD pixel unit array 700 similar to FIG. 6, except microlenses 610 are removed from the figure for simplicity and clarity, according to an embodiment of the invention. Four pixel 702, 704, 706, and 708 of the same pixel unit are denoted as Up-left (Ul), Up-right (Ur), Down-left (Dl), and Down-right (Dr) pixels, respectively. QPD pixel unit array 700 may be part of a QPD image.

FIG. 7B illustrates the QPD image being divided into a Ul view 710, a Ur view 720, a Dl view 730, and a Dr view 740, according to an embodiment of the invention. Ul view 710 is a collection of Ul pixels. Ul view 710 comprises Ul pixels, including Ul pixel 702. Ur view 720 is a collection of Ur pixels. Ur view 720 comprises Ur pixels, including Ur pixel 704. Dl view 730 is a collection of Dl pixels. Dl view 730 comprises Dl pixels, including Dl pixel 706. Dr view 740 is a collection of Dr pixels. Dr view 740 comprises Dr pixels, including Dr pixel 708. Combining Ul and Dl pixels, and Ur and Dr pixels will result in a left (L) pixel and right (R) pixel, respectively. The combined L pixel and R pixel are similar to L pixel 310 and R pixel 308 of FIG. 3B and L pixel 402 and R pixel 404 of FIG. 4.

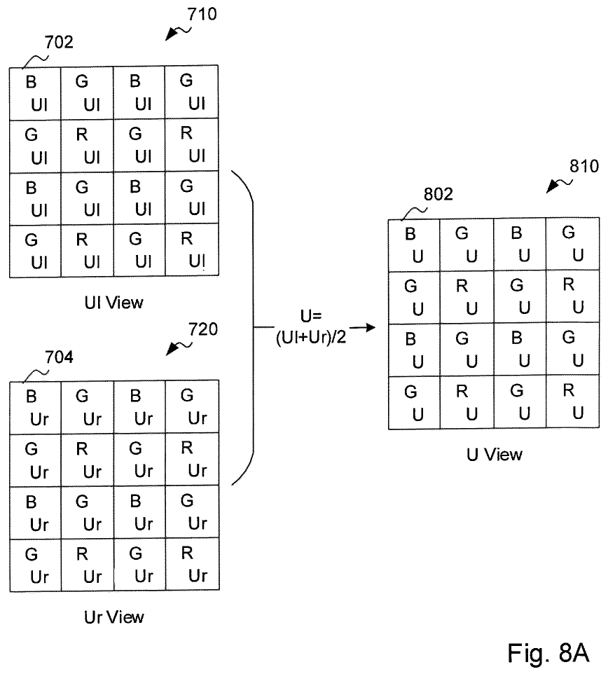

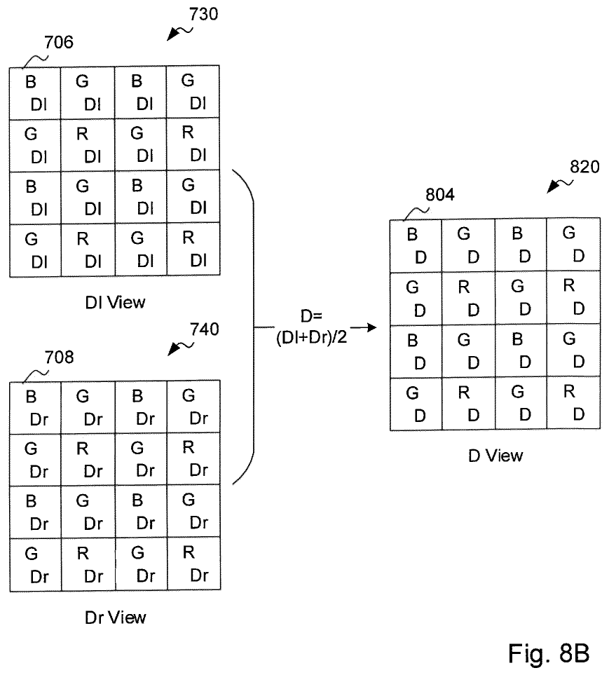

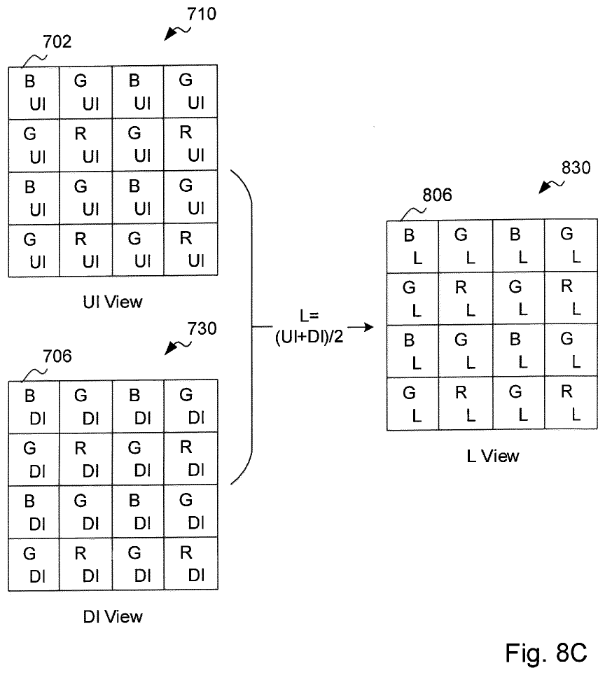

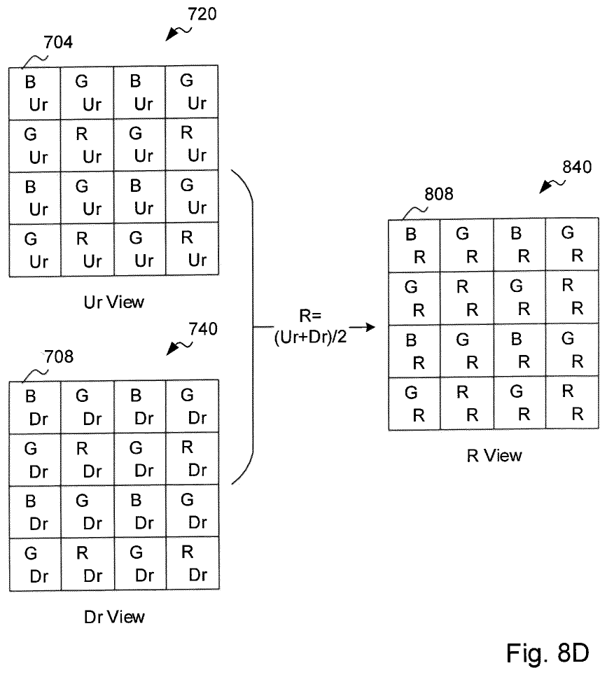

FIG. 8A shows an Up (U) view 810, which is the mean of Ul view 710 and Ur view 720, according to an embodiment of the invention. For example, a blue pixel 802 is the mean of Ul pixel 702 and Ur pixel 704.

FIG. 8B shows a Down (D) view 820, which is the mean of Dl view 730 and Dr view 740, according to an embodiment of the invention. For example, a blue pixel 804 is the mean of Dl pixel 706 and Dr pixel 708.

FIG. 8C shows a Left (L) view 830, which is the mean of Ul view 710 and Dl view 730, according to an embodiment of the invention. For example, a blue pixel 806 is the mean of Ul pixel 702 and Dl pixel 706.

FIG. 8D shows a Right (R) view 840, which is the mean of Ur view 720 and Dr view 740, according to an embodiment of the invention. For example, a blue pixel 808 is the mean of Ur pixel 704 and Dr pixel 708.

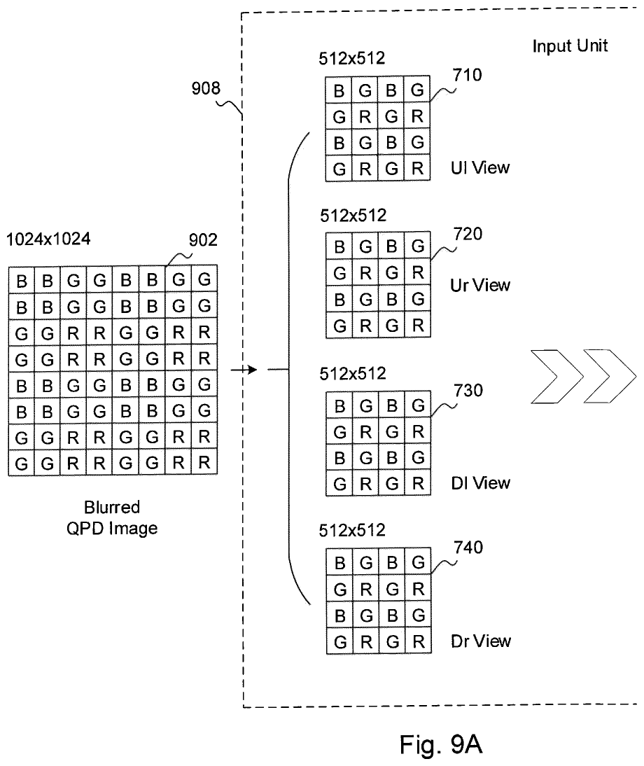

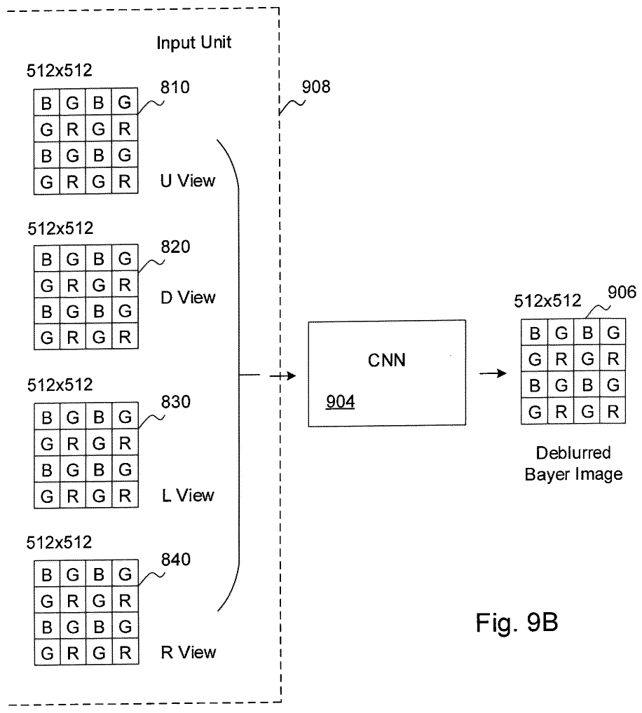

FIG. 9A illustrates a part of a QPD deblurring CNN 904, according to an embodiment of the invention. FIG. 9A shows a blurred input QPD image 902 having QPD pixel unit array 700. Each pixel unit comprising four pixels, Ul pixel 702, Ur pixel 704, Dl pixel 706, and a Dr pixel 708, under a microlens 610. An input unit 908 collects Ul pixels 702 in Ul view 710, Ur pixels 704 in Ur view 720, Dl pixels 706 in Dl view 730, and Dr pixels 708 in Dr view 740, as shown in FIG. 7B.

FIG. 9B illustrates another part of the QPD deblurring CNN 904, according to an embodiment of the invention. Input unit 908 defines U view 810 as the mean of the Ul view 710 and Ur view 720, D view 820 as the mean of Dl view 730 and Dr view 740, L view 830 as the mean of Ul view 710 and Dl view 730, and R view 840 as the mean of Ur view 720 and Dr view 740, following processes shown in FIGS. 8A-8D. U view 810, D view 820, L view 830, and R view 840 are input to CNN 904 to produce deblurred Bayer image 906. For example, U view 810, D view 820, L view 830, and R view 840 are 512×512 Bayer images, respectively, output deblurred Bayer image 906 is also a 512×512 image. Output Bayer image 906 is a deblurred image of blurred input QPD image 902.

Comparing to FIG. 5, CNN 504 produces deblurred image using left view 502A and right view 502B. Left view 502A and right view 502B have blur information and disparity information along left right direction. In addition to blur information, CNN 904 in FIG. 9B processes disparity information in two directions, which are left right direction and up down direction. Thus, CNN 904 of FIGS. 9A and 9B using QPD image produces better deblurred image than one produced using DPD image shown in FIG. 5.

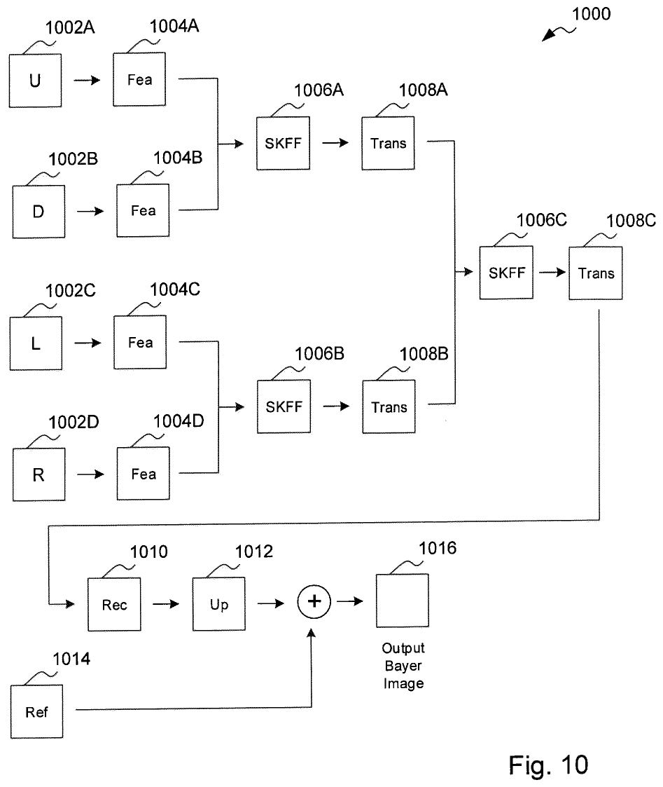

FIG. 10 shows a flowchart 1000 of a QPD deblurring CNN 904, according to an embodiment of the invention. A first input 1002A, which may be U view 810 of FIG. 9B, is input to a first feature extraction unit 1004A. For example, the data structure of U view 810 (first input 1002A) is 512×512×1. First feature extraction unit 1004A outputs features having, for example, 126×126×64 data structure.

The data structure is expressed as W×H×D. W is width, H is height, as in a 2D image. D is depth. When D=1, W×H×1 is simply a 2D image. When D is a number larger than 1, it may be considered data structure in feature domain having D channels or Depth=D. Although, W and H can be any number, in practice the processed data size is limited due to the computer processing power. In an embodiment, a patch of data for W=512 and H=512 (512×512 window) is used. The whole image is obtained by combining all processed patches.

A second input 1002B, which may be D view 820 of FIG. 9B, is input to a second feature extraction unit 1004B. For example, the data structure of D view 820 (second input 1002B) is 512×512×1. Second feature extraction unit 1004B outputs features having, for example, 126×126×64 data structure.

The output from first feature extraction unit 1004A and the output from second feature extraction unit 1004B are input to a first selective kernel feature fusion (SKFF) unit 1006A. First SKFF unit 1006A fuses features from kernels having difference scales. The output from first SKFF unit 1006A is input to a first transformer 1008A. A transformer is a part of CNN that aims to solve sequence-to-sequence tasks while handling long range dependencies with ease.

A third input 1002C, which may be L view 830 of FIG. 9B, is input to a third feature extraction unit 1004C. For example, the data structure of L view 830 (third input 1002C) is 512×512×1. Third feature extraction unit 1004C outputs features having, for example, 126×126×64 data structure.

A fourth input 1002D, which may be R view 840 of FIG. 9B, is input to a fourth feature extraction unit 1004D. For example, the data structure of R view 840 (fourth input 1002D) is 512×512×1. Fourth feature extraction unit 1004D outputs features having, for example, 126×126×64 data structure.

The output from third feature extraction unit 1004C and the output from fourth feature extraction unit 1004D are input to a second SKFF unit 1006B. The output from second SKFF unit 10006B is input to a second transformer 1008B.

The output from first transformer 1008A and the output of second transformer 1008B are input to a third SKFF unit 1006C. The output from third SKFF unit 10006C is input to a third transformer 1008C. The output from third transformer 1008C is input to a reconstruction unit 1010. A reconstruction unit reconstructs image such that the features of the reconstructed image are close to those of the target image.

The output of reconstruction unit 1010 is input to an upsample unit 1012. The input to upsample unit 1012 has 128×128×64 data structure, upsample unit 1012 changes the data structure to 512×512×1, which is same as the original inputs. The original inputs are U view 810, D view 820, L view 830, and R view 840. The output from upsample unit 1012 is combined with a reference image 1014 to produce an output Bayer image 1016 having 512×512×1 data structure, which is a 512×512 2D image. Reference image 1014 may be (L view+R view)/2, which is same as (U view+D view)/2. Noticed that (L view+R view)/2=(U view+D view)/2=(Ul view+Ur view+Dl view+Dr view)/4. Output Bayer image 1016 is a deblurred image of blurred input QPD image 902.

Before CNN 904 can be used for producing deblurred image 906, CNN 904 must be trained with a number of training pairs, which are input-output pairs of blurred input QPD images including their U views, D views, L views, and R views, and the corresponding output ground truth deblurred Bayer images. The blurred input QPD image is a QPD Bayer image (as shown in FIG. 6) having a m×m size, and the output deblurred Bayer image has a ¼ (m×m) size, m is an integer.

While the present invention has been described herein with respect to the exemplary embodiments and the best mode for practicing the invention, it will be apparent to one of ordinary skill in the art that many modifications, improvements and sub-combinations of the various embodiments, adaptations, and variations can be made to the invention without departing from the spirit and scope thereof.

The terms used in the following claims should not be construed to limit the invention to the specific embodiments disclosed in the specification and the claims. Rather, the scope is to be determined entirely by the following claims, which are to be construed in accordance with established doctrines of claim interpretation. The present specification and figures are accordingly to be regarded as illustrative rather than restrictive.

What is claimed is:

1. A system for deblurring quad-photodiode (QPD) image, comprising:
a blurred input QPD image comprising a plurality of pixel units, each pixel unit comprising four pixels, an Up-left (Ul) pixel, an Up-right (Ur) pixel, a Down-left (Dl) pixel, and a Down-right (Dr) pixel, under a microlens;
an input unit collecting the Ul pixels in a Ul view, the Ur pixels in a Ur view, the Dl pixels in a Dl view, and the Dr pixels in a Dr view;
wherein the input unit defines a U view as a mean of the Ul view and the Ur view, a D view as a mean of the Dl view and the Dr view, a L view as a mean of the Ul view and the Dl view, and a R view as a mean of the Ur view and the Dr view;
a convolutional neural network (CNN), wherein the U view, the D view, the L view, and the R view are input to the CNN;
wherein the CNN outputs an output Bayer image, which is a deblurred image of the blurred input QPD image.

2. The system of claim 1, wherein a size of the input QPD image is m×m and a size of the output Bayer image is ¼ (m×m), m is an integer.

3. The system of claim 1, wherein in the CNN:
the U view is input to a first feature extraction unit;
the D view is input to a second feature extraction unit;
the L view is input to a third feature extraction unit; and
the R view is input to a fourth feature extraction unit.

4. The system of claim 3, wherein in the CNN:
an output of the first feature extraction unit and an output of the second extraction unit are input to a first selective kernel feature fusion (SKFF) unit, and an output of the third feature extraction unit and an output of the fourth extraction unit are input to a second SKFF unit;
an output of the first SKFF unit is input to a first transformer;
an output of the second SKFF unit is input to a second transformer;
an output of the first transformer and an output of the second transformer are input to a third SKFF unit;
an output of the third SKFF unit is input to a third transformer;
an output of the third transformer is input to a reconstruction unit;
an output of the reconstruction unit is input to a upsample unit;
an output of the upsample unit is combined with a reference image to produce the output Bayer image.

5. The system of claim 4, wherein the reference image is a mean of the L view and the R view.

6. The system of claim 4, wherein the reference image is a mean of the U view and the D view.

7. The system of claim 4, wherein the reference image is a mean of the Ul view, the Ur view, the Dl view, and the Dr view.

8. The system of claim 4, wherein the U view has 512×512×1 data structure and an output of the first feature extraction unit has 126×126×64 data structure.

9. The system of claim 1, wherein the CNN is trained using input-output pairs of blurred QPD images and ground truth deblurred Bayer images.

10. A method for deblurring quad-photodiode (QPD) image comprising:
providing a blurred input QPD image comprising a plurality of pixel units, each pixel unit comprising four pixels, an Up-left (Ul) pixel, an Up-right (Ur) pixel, a Down-left (Dl) pixel, and a Down-right (Dr) pixel, under a microlens;
collecting the Ul pixels in a Ul view, the Ur pixels in a Ur view, the Dl pixels in a Dl view, and the Dr pixels in a Dr view;
defining a U view as a mean of the Ul view and the Ur view, a D view as a mean of the Dl view and the Dr view, a L view as a mean of the Ul view and the Dl view, and a R view as a mean of the Ur view and the Dr view;
inputting the U view, the D view, the L view, and the R view into a convolutional neural network (CNN);
outputting an output Bayer image from the CNN, wherein the output Bayer image is a deblurred image of the QPD image.

11. The method of claim 10, wherein a size of the input QPD image is m×m and a size of the output Bayer image is ¼ (m×m), m is an integer.

12. The method of claim 10 further comprising steps in the CNN:
inputting the U view to a first feature extraction unit;
inputting the D view to a second feature extraction unit;
inputting the L view to a third feature extraction unit; and
inputting R view to a fourth feature extraction unit.

13. The method of claim 12 further comprising steps in the CNN:
inputting an output of the first feature extraction unit and an output of the second extraction unit to a first selective kernel feature fusion (SKFF) unit;
inputting an output of the third feature extraction unit and an output of the fourth extraction unit to a second SKFF unit;
inputting an output of the first SKFF unit to a first transformer;
inputting an output of the second SKFF unit to a second transformer;
inputting an output of the first transformer and an output of the second transformer to a third SKFF unit;
inputting an output of the third SKFF unit to a third transformer;
inputting an output of the third transformer to a reconstruction unit;
inputting an output of the reconstruction unit to a upsample unit;
combining an output of the upsample unit with a reference image to produce the output Bayer image.

14. The method of claim 13, wherein the reference image is a mean of the L view and the R view.

15. The method of claim 13, wherein the reference image is a mean of the U view and the D view.

16. The method of claim 13, wherein the reference image is a mean of the Ul view, the Ur view, the Dl view, and the Dr view.

17. The method of claim 13, wherein the U view has 512×512×1 data structure and an output of the first feature extraction unit has 126×126×64 data structure.

18. The method of claim 10, wherein the CNN is trained using input-output pairs of blurred QPD images and ground truth deblurred Bayer images.
